(19) United States
(12) Patent Application Publication
(10) Pub. No.: US 2025/0310786 A1
(43) Pub. Date: Oct. 2, 2025

(54) FACILITATING FACILITATING DYNAMIC NETWORK TRAFFIC STEERING USING GRAPH NEURAL NETWORKS IN ADVANCED COMMUNICATION NETWORKS

(71) Applicant: Dell Products, L.P., Round Rock, TX (US)

(72) Inventors: Umair Sajid Hashmi, Mississauga (CA); Marwan Mansour, Alexandria (EG); Jeebak Mitra, Ottawa (CA); Gwenael Poitau, Montreal (CA)

(21) Appl. No.: 18/624,285

(22) Filed: Apr. 2, 2024

(51) Int. Cl. H04W 16/28; H04W 16/18

(52) U.S. Cl. CPC H04W 16/28; H04W 16/18

(57) ABSTRACT

Facilitating dynamic network traffic steering using graph neural networks in advanced communication networks is provided. A method includes determining respective results of application of a utility function to all combinations of potential handovers of the specified user equipment from a source cell to respective target cells of a group of target cells. A communication network can include the source cell and the group of target cells. The operations can also include, based on the respective results of the application of the utility function, implementing a network traffic steering process that moves connectivity of the user equipment from the source cell to a single target cell of the group of target cells.

### BACKGROUND

The use of computing devices is ubiquitous. Given the explosive demand placed upon mobility networks and the advent of advanced use cases (e.g., streaming, gaming, and so on), power consumption in such networks is higher as compared to Long Term Evolution (LTE) networks, for example. Such power consumption can be attributed to the exponential increase in the network traffic flowing through the advanced network and the need for faster processing of complex tasks. Accordingly, unique challenges exist related to network efficiency and in view of forthcoming Fifth Generation (5G), new radio (NR), Sixth Generation (6G), or other next generation, standards for network communication.

The above-described context with respect to communication networks is merely intended to provide an overview of current technology and is not intended to be exhaustive. Other contextual descriptions, and corresponding benefits of some of the various non-limiting embodiments described herein, will become further apparent upon review of the following detailed description.

### SUMMARY

The following presents a simplified summary of the disclosed subject matter to provide a basic understanding of some aspects of the various embodiments. This summary is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

An embodiment relates to a method that includes determining, by a system comprising at least one processor, respective results of application of a utility function to respective combinations of a specified user equipment of a source cell and respective target cells of a group of target cells. A communication network comprises the source cell and the group of target cells. The method also includes, based on the respective results of the application of the utility function, facilitating, by the system, an action for a network traffic steering process that moves network traffic of the specified user equipment from the source cell to a single target cell of the group of target cells.

According to some implementations, determining of the respective results of the application of the utility function can include determining a first result of application of the utility function to the specified user equipment and a first target cell of the group of target cells and determining a second result of application of the utility function to the specified user equipment and a second target cell of the group of target cells. Further to these implementations, the method can include, based on the first result being determined to satisfy a defined threshold and the second result being determined to fail to satisfy the defined threshold, selecting the first target cell as the single target cell.

In some implementations, the method can include, using, by the system, a first model that determines a first output related to the network traffic steering process. The method can also include using, by the system, a second model that determines a second output related to the network traffic steering process. Inputs to the second model, during a first iteration, can include the first output of the first model, tabular input features, and a graphical network representation. The method also includes using, by the system, a third model trained to follow a loss metric of the second model. An input to the third model is an error metric of the second model. Further, the method includes implementing, by the system, a gradient boosting process that comprises using an iterative process for sequential training of the second model. An output of the third model is utilized as an input to the second model via a feedback loop during subsequent iterations that are subsequent to the first iteration. In an example, the first model is a first gradient boosted decision tree model, the second model is a graph neural network model, and the third model is a second gradient boosted decision tree model.

The utility function can be based on an optimization function that facilitates a tradeoff between user equipment quality of service and an energy consumption of the communication network. The user equipment quality of service can be defined for respective user equipment classes of user equipment within the communication network. In another example, the respective results of the application of the utility function comprise binary classifications.

According to some implementations, the communication network is deployed as a disaggregated architecture that comprises central units, distributed units, and a near-real-time-radio access network intelligent controller. According to some implementations, the group of target cells is configured to operate according to a new radio network communication protocol. In some implementations, the group of target cells can be configured to operate according to a fifth generation network communication protocol.

Another embodiment relates to a system that includes a processor and a memory that stores executable instructions that, when executed by the processor, facilitate performance of operations. The operations can include performing a traffic steering procedure that moves network traffic of a user equipment from a source cell to a defined target cell within a communication network. Performing the traffic steering procedure can include determining respective results of application of a utility function to respective combinations of the user equipment and respective target cells of a group of target cells of the communication network. Further, performing the traffic steering procedure can include, based on the respective results and a determination that the defined target cell satisfies a set of handover conditions, transferring the network traffic of the user equipment from the source cell to the defined target cell.

In some implementations, the operations can include using a first model that determines a first output related to the traffic steering procedure and using a second model that determines a second output related to the traffic steering procedure. Inputs to the second model, during a first iteration, can include the first output of the first model, tabular input features, and a graphical network representation. Further, the operations can include using a third model trained to follow a loss metric of the second model. An input to the third model is an error metric of the second model. Further, the operations can include implementing a gradient boosting process that comprises using an iterative process for sequential training of the second model. An output of the third model is utilized as an input to the second model via a feedback loop during subsequent iterations that are subsequent to the first iteration. In an example, the first model is a first gradient boosted decision tree model, the second model is a graph neural network model, and the third model is a second gradient boosted decision tree model.

The utility function can be based on an optimization function that facilitates a tradeoff between user equipment quality of service and an energy consumption of the communication network. Further, the user equipment quality of service is defined for respective user equipment classes of user equipment within the communication network.

Yet another embodiment relates to a non-transitory machine-readable medium, comprising executable instructions that, when executed by a processor of network equipment, facilitate performance of operations. The operations can include determining respective results of application of a utility function to all combinations of potential handovers of the specified user equipment from a source cell to respective target cells of a group of target cells. A communication network can include the source cell and the group of target cells. The operations can also include, based on the respective results of the application of the utility function, implementing a network traffic steering process that moves connectivity of the user equipment from the source cell to a single target cell of the group of target cells.

In some implementations, the operations can include using a first model that determines a first output related to the network traffic steering process and using a second model that determines a second output related to the network traffic steering process. Inputs to the second model, during a first iteration, can include the first output of the first model, tabular input features, and a graphical network representation. The operations can also include using a third model trained to follow a loss metric of the second model, wherein an input to the third model is an error metric of the second model. Further, the operations can include implementing a gradient boosting process that comprises using an iterative process for sequential training of the second model. An output of the third model is utilized as an input to the second model via a feedback loop during subsequent iterations that are subsequent to the first iteration.

Further to the above implementations, the first model can be a first gradient boosted decision tree model, the second model can be a graph neural network model, and the third model can be a second gradient boosted decision tree model, which can be a narrow gradient boosted decision tree model and is different than the first gradient boosted decision tree model.

According to some implementations, the utility function is based on an optimization function that facilitates a tradeoff between user equipment quality of service and an energy consumption of the communication network. The user equipment quality of service can be defined for respective user equipment classes of user equipment within the communication network.

To the accomplishment of the foregoing and related ends, the disclosed subject matter includes one or more of the features hereinafter more fully described. The following description and the annexed drawings set forth in detail certain illustrative aspects of the subject matter. However, these aspects are indicative of but a few of the various ways in which the principles of the subject matter can be employed. Other aspects, advantages, and novel features of the disclosed subject matter will become apparent from the following detailed description when considered in conjunction with the drawings. It will also be appreciated that the detailed description can include additional or alternative embodiments beyond those described in this summary.

### BRIEF DESCRIPTION OF THE DRAWINGS

Various non-limiting embodiments are further described with reference to the accompanying drawings in which:

FIG. 1 illustrates an example, non-limiting, network environment that utilizes traffic steering in accordance with one or more embodiments;

FIG. 2 illustrates an example, non-limiting, equation for an optimization function according to one or more embodiments;

FIG. 3 illustrates an example, non-limiting, high-level flow diagram for user equipment-centric traffic steering decision making in accordance with one or more embodiments described herein;

FIG. 4 illustrates an example, non-limiting, flow diagram for dynamic traffic steering in accordance with one or more embodiments described herein;

FIG. 5 illustrates an example, non-limiting network topology in accordance with one or more embodiments described herein;

FIG. 6 illustrates an example, non-limiting, controller that facilities traffic steering in accordance with one or more embodiments described herein;

FIG. 7 illustrates an example, non-limiting, computer-implemented method for traffic steering in accordance with one or more embodiments described herein;

FIG. 8 illustrates an example, non-limiting, system architecture in accordance with one or more embodiments described herein;

FIG. 9 illustrates an example, non-limiting, message sequence flow chart that can facilitate dynamic network traffic steering using graph neural networks in accordance with one or more embodiments described herein;

FIG. 10 illustrates a flow diagram of an example, non-limiting, computer-implemented method that facilitates traffic steering in advanced communication networks in accordance with one or more embodiments described herein;

FIG. 11 illustrates an example, non-limiting, computing environment in which one or more embodiments described herein can be facilitated; and

FIG. 12 illustrates an example, non-limiting, networking environment in which one or more embodiments described herein can be facilitated.

### DETAILED DESCRIPTION

One or more embodiments are now described more fully hereinafter with reference to the accompanying drawings in which example embodiments are shown. In the following description, for purposes of explanation, numerous specific details are set forth in order to provide a thorough understanding of the various embodiments. However, the various embodiments can be practiced without these specific details. In other instances, well-known structures and devices are shown in block diagram form in order to facilitate describing the various embodiments.

As wireless networks become denser and cater to diverse user equipment (UE) types and demands, optimal resource allocation of resources within the network becomes a challenge. In a network environment, there is need to switch the traffic across cells based on changes in radio environment, user mobility, and/or application requirements to satisfy performance requirements. This may also necessitate a traffic split across multiple tiers (e.g., macro, small cells).

Often times the allocation of the resources tends to become wasteful over the course of time if the allocation of resources are not updated optimally per the channel conditions. Accordingly, the network should transition to a more optimal state that better matches the current demand and traffic. This is referred to as traffic steering when it is performed for a group of cell sites that have adjacencies and/or dependencies.

The objective of traffic steering (TS) can include fairly (e.g., as evenly as possible) distributing the UE traffic load between cell sites (e.g., load balancing). This can ensure greater quality of service (QOS) for higher priority traffic classes and the like. In the TS process, first UEs from a congested and/or overloaded cell are identified for handover (HO) to a neighboring cell. Upon or after identification of the UEs, the HO is initiated to redirect their link with the new base station (BS), cell, and/or carrier.

The motivation behind TS within networks is that existing Radio Resource Management (RRM) features are cell-centric. For example, instead of treating UEs independently, the average cell-centric performance for network management is utilized. Due to variations in the network environment, neighbor cell coverage, interference patterns, and so on, the network performance may be improved by efficiently offloading UEs between cells, BSs, and/or carriers to optimize network-wide performance metrics.

Additionally, traffic management within existing networks is reactive in nature, and does not take advantage of predictive capabilities to predict network and UE performance. If UE traffic is not managed efficiently among a group of cells and/or BSs, the overall UE and network performance suffers. This can result in suboptimal spectrum utilization, reduced throughput, and increased handover failure.

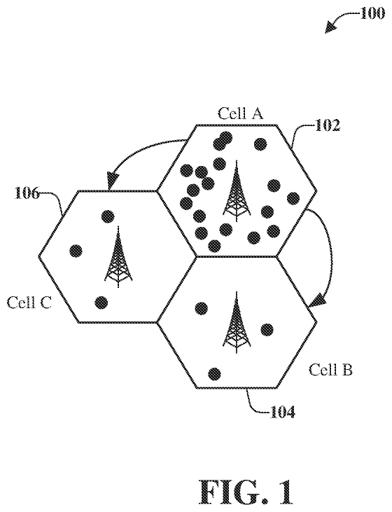

FIG. 1 illustrates an example, non-limiting, network environment 100 that utilizes traffic steering in accordance with one or more embodiments. The network environment 100 includes multiple cells, illustrated as Cell A 102, Cell B 104, and Cell C 106. Each cell includes one or more UEs, denoted by the circles within the cells. As illustrated, Cell A 102 is more heavily loaded with UEs as compared to Cell B 104 and Cell C 106. Therefore, UE traffic from heavily loaded Cell A 102 should be steered (e.g., handed off, communication links transferred) to lightly loaded Cell B 104 and/or Cell C 106.

With growth in traffic as well as diverse bands and radio access technologies (RATs), to maintain a balanced distribution of network traffic, the network traffic should be distributed and switched across multiple radios, access technologies, and/or carriers.

In addition, steering traffic across multiple base stations (BSs) and carriers within a single RAT can allow for improving user quality of satisfaction (QoS) and improve energy efficiency (EE) of the network. Some conventional TS processes have considered Radio Frequency (RF) condition variations due to user mobility, some have considered average cell-level UE throughput, while others have considered both key performance indicators (KPIs) simultaneously.

Instead of a load counter based (which could be based on number of connected UEs, cell load, and so on) or passive TS based on average cell-level KPIs, the disclosed embodiments utilize user equipment (UE)-centric TS, which focuses on UE-level performance metrics instead of average cell-based statistics. Further, as discussed herein, the TS decisions take multiple factors, such as neighboring cell coverage, signal strength, and/or interference status, in consideration. In addition, instead of performing TS on a per cell basis using isolated mechanisms such as anomaly detection based on user QoS KPIs, the TS decisions should be performed on a per cell cluster level to optimize cluster level UE KPIs, as provided herein.

It is noted that, for the avoidance of doubt, any embodiments described herein in the context of optimizing resource allocation, one or more states, spectrum utilization, and so on are not so limited and should be considered also to cover any techniques that implement underlying aspects or parts of the described aspects to improve or increase resource allocation, one or more states, spectrum utilization, and so on, even if resulting in a sub-optimal variant obtained by relaxing aspects or parts of a given implementation or embodiment.

Provided herein is a data-driven TS approach for a multi-cell network based on the maximization of a long-term utility function that achieves a tradeoff between user QoS, network energy consumption, and the cost of TS in terms of handover frequency of UEs. The tradeoff can be modelled by the network operator-intent and can prioritize a different KPI in a given spatio-temporal region. For example, a first decision can be based on the first location and a first time, a second decision can be based on the second location and a second time, and so on. Thus, the prioritization between QoS and network energy consumption can be different based on the time and place (and UE device classes) under consideration.

Also provided herein is a system architecture, method, and other embodiments that perform dynamic traffic steering for a cluster of cells. The dynamic traffic steering may be triggered after a preset time interval and/or through system defined thresholds such as cell load limit or QoS degradation metric for the UEs within the cluster. The framework takes into consideration the spatial adjacencies within the cluster with statistical indicators incorporated within a learning model.

The optimization problem can be formulated over a cluster of cells with an objective of optimizing the tradeoff between KPIs such as cluster wide EE, UE QoS, and so on, for a diverse class of UEs, while minimizing the number of handovers to avoid a ping pong effect (e.g., UEs being transferred often). The UE device class referred to herein is the QoS class of the requested traffic. At a very high level, this can simply be guaranteed bit rate (GBR) versus non-GBR traffic. A UE device class implies that devices (in the different classes) are requesting applications with different KPIs and target levels, so their satisfaction should be measured across the relevant KPIs. Examples include, but are not limited to, enhanced Mobile Broadband (eMBB), Ultra-reliable low-latency communications (URLLC), Massive Machine Type Communications (mMTC), and so on.

The disclosed embodiments include a control flow architecture in a disaggregated network architecture such as Open radio access network (O-RAN), to depict the interaction of the controller with E2 nodes and dynamic execution of the TS based on the model recommendations. However, it is noted that the O-RAN embodiment is merely an example and other types of disaggregated network architecture can be utilized.

Conventional methods for traffic steering are static and are based on thresholds on cell loads (e.g., number of users connected, PRB utilization) or user QoS level (e.g., mean cell throughput). Thus, traffic steering, in such conventional methods, is performed when a certain cell load has been reached, or a QoS or average service latency has increased beyond a certain point. However, such methods are reactive in nature and do not provide proactive traffic steering policies or use the knowledge of graphical interconnectivity to provide policies that will yield long term performance improvement without excessive handovers. Recent literature has proposed using Artificial Intelligence (AI) and/or Machine Learning (ML) techniques for dynamic handovers in heterogeneous networks. However, these methods lack utilization of the spatial dependencies within the network which, if used through graph neural networks, enhances the prediction performance of the designed processes, as discussed herein.

A novelty provided herein is a utility function that is used to determine the actions to be undertaken as part of the TS process. The utility function is based on maximizing EE while maintaining the UE QoS and limiting the frequency of HOs within the cell cluster. Thus, an aspect is related to controlling the number of HOs that take place both within and outside of the TS process. It is noted that other HOs might be taking place for various reasons other than the TS process. For example, one or more UEs might determine that a nearby cell is providing a better received signal power and might request HO to those particular cells. Thus, it is not only the HOs that are generated by the TS process discussed herein, but other HOs are also happening, so the total number of HOs occurring should be regulated.

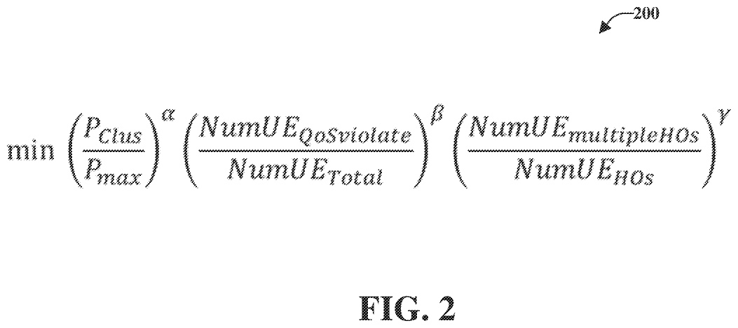

Through the network operator intent, the utility function may be traded off between the cluster EE, UE QoS ratio, and the HO costs that are associated in the process of TS. The optimization function for the problem is given in FIG. 2, which illustrates an example, non-limiting, equation 200 for an optimization function according to one or more embodiments. The optimization function is a minimization function where the first factor is how much power is being consumed within the cluster as a ratio of the maximum power. For example, the consideration is that if all cells are operating at maximum power, considering that maximum, what is the power consumption level at a given time.

Another factor is the UE QoS, which is determined based on the number of UEs which have violated the KPI threshold divided by the total number of UEs. For example, if there are 100 UEs in the cluster and 10 UEs do not meet the QoS threshold. It is noted that the QoS threshold is functionally dependent on the UE device class and what are the KPI and the limits of those KPIs for that particular class of QoS flow. Based on those thresholds, it is determined how many UEs are not satisfying the QoS, which should also be minimized.

Yet another factor is the number of UEs that have multiple HOs within a given interval divided by the total number of UEs that are steered to different cells. For example, if 10 UEs have been handed over in a given interval, out of those 10 UEs, which ones were shifted multiple times. The number of times a UE is handed over should be minimized in order to avoid a ping pong effect.

The optimization is performed using TS actions by a central entity optimizing the cluster level performance. The first bracket represents the power consumption ratio, the second bracket represents the UE QOS dissatisfaction ratio, and the third bracket displays the ping pong effect induced through the TS mechanism within the cluster.

The details of the variables used in the equation 200 will now be described. Variable P_{Clus} is the overall cluster power consumption within a decision interval (averaged). Variable Pₘₐₓ is the maximum cluster power consumption based on full load scenario and transmission on all downlink (DL) resources (time and frequency). Variable PNumUE_{QoSviolate} is the number of UEs violating the KPI thresholds within a decision interval (averaged). Variable NumUE_{Total} is the total number of UEs present in the cluster within a decision interval (averaged). Variable NumUE_{multipleHOs} is the number of UEs steered to other cells on multiple occasions by the central entity in order to optimize the utility function within a decision interval (averaged). Variable NumUE_{HOs} is the total number of UEs steered to different cells by the central entity for improving the utility function within a decision interval (averaged). Variables α, β, and γ are the network operator intent based tradeoff between EE, UE QoS, and TS HO costs, respectively. The variables α, β, and γ are configurable and can change over time, place, and/or a current priority, all of which can change given various circumstances.

Another novelty relates to a system architecture that includes a GNN based learning model. The learning model architecture includes gradient boosted decision trees (GBDT) and a graph neural network (GNN) to yield probability values for a selection of UEs that are to be offloaded to suitable nearby cells in order to improve the network utility described above.

The combined effect of GBDT training on tabular network data, along with training the GNN on the GBDT learned representations, as well as graph-structured spatial information of the network, can improve the binary classification (whether a UE should be handed over to a neighbor cell or not) performance when compared to each model being trained independently. An embodiment can include the use of a heterogenous non-graphical data (such as tabular data set extracted from databases storing the network performance statistics) containing network statistics to populate the node features of a graphical representation of the network. Such an architecture is suited to optimize the utility function described above with respect to the utility function that is used to determine the actions to be undertaken as part of the TS process.

An iterative mechanism can then be used for sequential training of the GBDT and the GNN. The output prediction of the GBDT is fed in the GNN (e.g., via a feedback loop). Accordingly, the GBDT is refined in each successive iteration based on the GNN error metrics. The trained GNN model can be modified by the iterative updates in GBDT which follows the gradient updates in the GNN. Since the goal of the GNN is to perform binary classification in predicting whether a UE should be handed over to another cell, binary cross-entropy can be used as the loss function for GNN.

Yet another novelty provided herein relates to UE-centric TS decision making. The model includes a traffic steering application which takes the input of the probabilities yielded from the HO class prediction application to yield the final policies proposed for TS. For each UE, if the probability for belonging to the HO class is above an operator defined threshold, the handover is performed for the UE given the UE meets the received power criteria from the nearby cell. Other thresholds to be taken under consideration for implementation of the HO is if the maximum number of UEs connected with the target cell has been reached. Various factors can be considered within this application (e.g., the UE-centric TS decision making) to determine whether one or more UEs are to be steered to the target cell. The factors to be considered include whether a UE has been recommended for HO to multiple cells, what is the current cell load of the target cell, does the UE meet the minimum channel quality, RSRP, and so on. Based on the rule-based criteria containing the factors mentioned above, the final policy recommendation is formulated to be transferred to the network nodes.

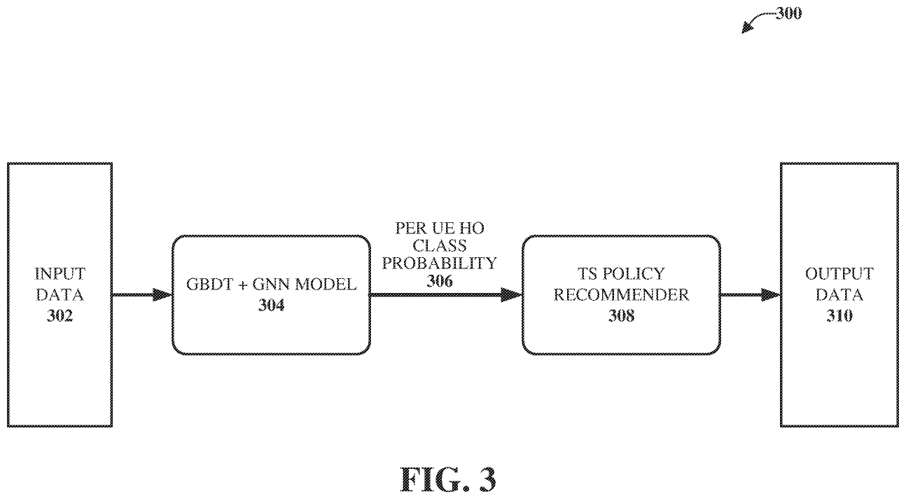

In further detail, FIG. 3 illustrates an example, non-limiting, high-level flow diagram 300 for UE-centric TS decision making in accordance with one or more embodiments described herein. As illustrated, input data 302 is provided to a GBDT+GNN model 304. The input data 302 can include, for example, information indicative of heterogenous network statistics, which can be in the form of tabular data, and/or information indicative of a network graph structure. A per UE HO class probability 306 is output from the GBDT+GNN model 304 and used as input to a TS policy recommender 308. Output data 310 of the TS policy recommender 308 includes TS policies, which are defined for each UE.

Thus, the high-level flow diagram 300 illustrates the overall structure. Instead of HO decision being made on a threshold level basis (e.g., cell A has to hand over 10 UEs to cell B), the disclosed embodiments make decisions that are UE centric in the sense that, for every UE, a determination is made whether that particular UE should be handed over or not. The determination is made based on a binary classification whether the UE should be handed over or not (e.g., yes, or no). There is the output and the TS policy, which decides whether a particular should be handed over or not, depending on various criteria as discussed herein.

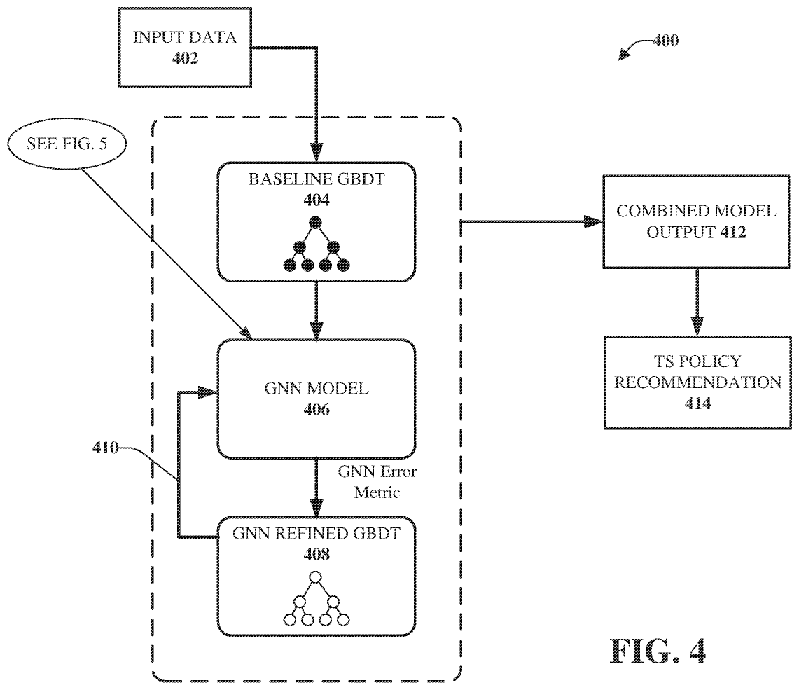

FIG. 4 illustrates an example, non-limiting, flow diagram 400 for dynamic traffic steering in accordance with one or more embodiments described herein. As illustrated, input data 402 is provided to a baseline GBDT 404. The input data 402 can include tabular data that includes information indicative of (or representing) network or node features. For example, the node features can include, but are not limited to: UE locations, BS locations, BS adjacency matrix, cell load statistics, UE KPI metrics, UE mobility measurements, HO statistics, received signal power measure, CQI measurements, and so on.

The input data 402 is provided to train the baseline GBDT 404. Gradient boosting is performed by adding several weak learners (e.g., normally shallow decision trees) in an iterative manner to reduce loss function via gradient descent in functional space.

A GBDT model is trained to predict whether each UE should be shifted to an adjoining cell for improvement in the network utility. The output of the GBDT is the predictions, which are concatenated to the original network features to form the training data set for a GNN. The GNN is modeled as a Graph Attention Network (GAT) which can incorporate attention mechanisms for capturing various relationships (including important relationships) between nodes in a graph.

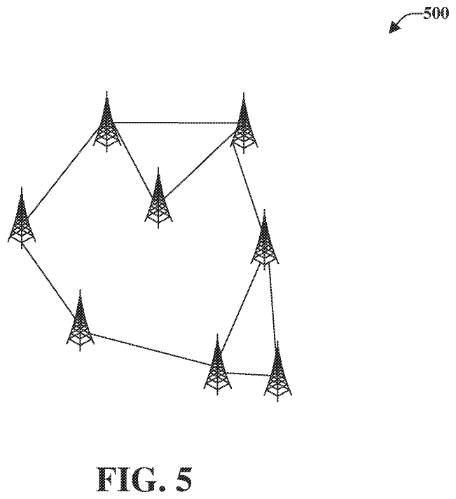

The GNN model 406 takes the concatenated feature set along with the network graph topology as input to yield a trained GNN model with some loss function and a set of optimized network features which are a function of the GNN error within the current iteration. FIG. 5 illustrates an example, non-limiting network topology 500 in accordance with one or more embodiments described herein. Illustrated in FIG. 5 are various nodes (depicted as base stations) and the network links between such nodes, for example purposes only.

The next iteration of the GBDT model (e.g., a GNN refined GBDT 408) takes the GNN error (e.g., GNN error metric) as the target variable and performs gradient descent to approximate this error, thereby improving GNN based prediction in the first step. The output from this iteration is a concatenated feature set combining GBDT predictions from the current and earlier iteration.

The GAT based GNN model 406 again performs backpropagation and yields the new difference (GNN model error) as input to the next GBDT iteration. With each iteration, the GNN model accuracy can be improved.

Thus, the GNN model 406 is trained using new network features and graphical network topology as input. The GNN refined GBDT 408 trains a new GBDT model on the original network features to approximate the GNN model error. The output of the GNN refined GBDT 408 is fed back to the GNN model, at 410. The updated network features based on concatenation of new predictions with previous network features is performed.

The end-to-end training of GBDT and GNN is continued for a defined number of iterations. Upon or after the defined number of iterations, a trained GNN model is obtained that uses GBDT as an embedding layer. The GBDT layer is used for feature transformation to improve the GNN prediction performance.

Upon or after the training of the GNN model is completed, a combined model output 412 is provided. The combined model output 412 is the trained GNN model for prediction of TS class probability per UE. The model output can be used by a RIC application (e.g., xApp) to provide TS recommendations per UE, according to an embodiment.

After being trained to a defined level of confidence on a variety of graph topologies and UE handover scenarios, the trained model is capable of receiving an unknown network topology and network features as input and yield probabilistic output for each UE within the network whether it should be handed over to an adjoining cell for improvement in the network utility. In case a UE is connected with a cell having multiple adjoining cells, the model will yield the probability output for each HO scenario.

The probabilities are used for TS recommendation using some network-intent based threshold (e.g., all UEs for which the model yields a higher HO probability) the application would provide a TS recommendation to the RRC layer. The RRC layer makes its decision based on whether the recommendation is violating any preset conditions, such as the maximum number of UEs connected to a cell, if the RSRP for the target cell is above the minimum requirement for the HO, and whether the UE has reached preset maximum number of HOs in a given time interval.

In further detail, the flow diagram 400 of FIG. 4 illustrates an iterative decision making process where the GBDT and the GNN are used and then a refined version of GBDT is used to make the final output determination. The data that is used to train the baseline GBDT 404 is the tabular data (e.g., the input data 402), which includes statistical information of the network. The task of GBDT is to try to predict which UE is a good candidate for HO. Thus, the baseline GBDT 404 is performing the first prediction in the flow diagram.

In the second step, the GNN model 406 can be a graph attention model. The GNN model 406 includes a mechanism within its process to model the relationships between the nodes that are included in the network. The GNN model 406 takes the representations or the predictions from the GBDT and concatenation (or joins) the prediction information with the original tabular input data (e.g., the input data 402). The GNN model 406 uses the network topology data, which is modeled as a graph, and takes that graph and trains itself on the prediction. The GNN model 406 is trying to replicate the same predictions as the baseline GBDT 404 and is predicting what is the probability of the UEs to be handed off. The graphical data (e.g., FIG. 5) assists by giving the GNN model 406 information about the neighborhood adjacency, the edges between the nodes, which of the nearby cells is a better candidate for HO as compared to another nearby cell, and so on, which is just one example of how that graphical information would be useful.

Upon or after the first pass of the GNN model 406 is completed (e.g., the first prediction), there is a loss function. The loss function is trying to model how close the predictions are to the actual predictions in terms of whether moving a particular UE would have actually improved the performance or not (e.g., how well the model predicted). Thus, there is a measure of the prediction accuracy of the GNN model 406. Taking that loss function (e.g., the GNN error metric) into consideration, there is a GNN refined GBDT 408. The refined GBDT process includes a narrower tree of the tree one that was used in the baseline GBDT. The purpose of the refined GBDT is to attempt to model the loss function. The refined GBDT is attempting to train itself within the loss function, and attempting to approximate what the error of the GNN model 406 should be. Once it trains itself on the error metric, the approximation of the GNN model, is fed back into the GNN model. In the next pass, the GNN tries to improve its prediction. Therefore, the GNN is iteratively trying to improve its prediction based on the GBDT's approximation of its loss function. This process repeats for multiple cycles between the second model (e.g., the GNN model 406) and the third model (e.g., the GNN refined GBDT 408). After multiple iterations, the GNN can improve its prediction based on the fed back that it received from the GNN refined GBDT 408. This is an iterative process. Upon or after the iterative process is completed, a combined model is output which can be in the form of a trained GNN model which can predict the TS class per UE. All those values can be used by the TS policy recommender module, which is an application in the network controller that provides TS recommendations per UE.

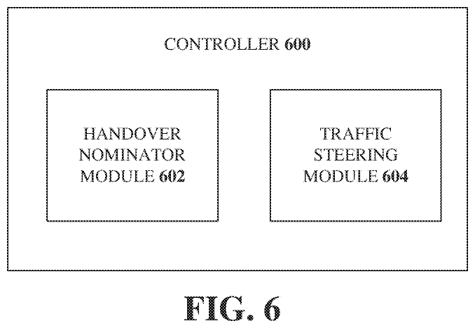

FIG. 6 illustrates an example, non-limiting, controller 600 that facilities traffic steering in accordance with one or more embodiments described herein. The controller 600 can be associated with a near-real-time RIC. The controller 600 includes a handover nominator module 602 and a traffic steering module 604.

The handover nominator module 602 is responsible for predicting the handovers that are highly likely to improve the utility function as previously discussed. In the proposed architecture, this handover nominator module 602 contains a pipeline of ML Models, which can include a Gradient Boosted Decision Tree (GBDT1) (e.g., the baseline GBDT 404), a Graph Neural Network (GNN) (e.g., the GNN model 406), and a Gradient Boosted Decision Tree (GBDT2) (e.g., the GNN refined GBDT 408).

The pipeline can be trained end-to-end (e.g., online, or offline outside the module), yielding a layer of feature embedding (GBDT1), and a topology-aware network that can recommend the handovers with the highest probability of improving the utility function. The resulting pipeline is deployed on the handover nominator module 602, which subscribes to network measurements required as input by the models. The nominations and/or recommendations predicted by the models are sent back to Traffic Steering xApp for decision making and handover execution.

The first ML model (GBDT1) uses network measurement data to nominate UEs for handovers. The output of the first model is a binary classification for each UE-Cell applicable pair (e.g., each UE with all its perceived neighboring cells). Subsequently, the output of the GBDT1 model (as enrichment data), the same network measurements input, and a graph representing the network topology is given as input to the GNN model. The GNN outputs the same target variable, while its prediction is enriched further with Network Topology data and the GBDT understanding of non-linear data. The output is also a nomination for UE-Cell pair handovers.

The second ML model (GBDT2) is trained to predict the error of the GNN model, and is given back to it as input to discount the error of GNN models. This GBDT model is based on following the GNN's loss metric and is a regression-based tree structure.

The training is performed by training the full iterative pipeline, using the given inputs and target variables. The training function converges when the loss function of the GNN model falls below a certain threshold, or another condition is satisfied, such as delta of change in loss is below a certain threshold. For example, the model can be trained to a defined confidence level.

The first GBDT model (GBDT1), as explained above, receives network measurements as input and outputs the probability of improving the utility function for each applicable UE-Cell HO pair.

Network measurement data that can be used as input include, but are not limited to: UE & BS locations; BS Adjacency Matrix; Cell load statistics; UE KPI metrics; UE Mobility measurements; HO statistics; Received signal power measures (DL RSRP per UE); CQI measurements (DL CQI per UE). The target variable is a per UE binary classification (0/1) in the form of probability of improving the utility function:

The prediction is a probability between 0%-100%, and the end user (e.g., the network operating entity) can define the threshold at which the prediction is rounded up to 1 (positive). Typically, the default threshold is at 50%. However, other default thresholds can be utilized.

Each input instance can be formatted as the aggregate of a given time period. For instance, each input instance is the aggregate of a full 1-second time window. This can be pre-processed by the xApp, prior to passing input to the model.

The output of GBDT1 is passed on through the pipeline to the GNN model as input, concatenated with the network measurements collected. This will now be explained in further detail below.

With reference also to FIG. 5, in the GNN model architecture, each node in a graph is represented based on its own values and its adjacent nodes values. This type of approach helps learn the spatial aspects of the network and the neighbor relations. In one embodiment, the Graph Attention Network architecture can be used to predict the probability of improving the utility function for each UE-Cell pair.

According to some implementations, the GNN can receive as input the network measurements including, but not limited to: UE & BS locations; BS Adjacency Matrix; Cell load statistics; UE KPI metrics; UE Mobility measurements; HO statistics; Received signal power measures (DL RSRP per UE); CQI measurements (DL CQI per UE). The GNN can also receive as input the Network Graph-formatted Topology and/or the outputs predicted by the GBDT1 for each instance. The Network Graph-formatted Topology is a graph representing the network where each node represents a Cell/BS, where the UE related info is embedded within the BS Cell/BS nodes. Additionally, the Network Graph-formatted Topology is a graph representing the network where the adjacency between the nodes is retrieved from the Automatic Neighbor Relation (ANR) information.

The target variable is the same as GBDT, although the GNN is enriched by the GBDT prior predictions, and the network topology information. This improves the GNN awareness of the network and the relationships between UEs and Cells. During training, the GNN is trained with a binary cross-entropy loss function to optimize the binary classification task.

The input to the second GBDT model (GBDT2) is the original network features along with the GNN loss function. Each training iteration updates the GBDT2 model by adding new trees that approximate the GNN loss function (binary classification cross-entropy). The target variable for the GBDT2 model is the negative gradient of the loss function of the GNN model with respect to the its concatenated input features multiplied by some learning rate. Since the GBDT2 model is approximating the loss function, this is a regression problem and the loss function for it is the root mean square error (RMSE) loss.

The combined model, once fully trained, is deployed in the network controller for inference where the GNN models provides per UE-Cell pair prediction of improvement in the utility function if the HO of the UE from its current cell to the target neighbor cell is executed. UE-Cell pair indicates that, for each UE, all the potential neighbor cells to which the UE can be handed over.

The traffic steering module 604 provides the final TS policy recommendations based on the per UE classification from the GBDT-GNN model it receives for each UE-neighbor_cell pair within the cluster. The traffic steering module 604 may be triggered either after a fixed time interval or when there is UE QoS degradation caused by mismatched loads between cells.

It checks on a per UE basis whether there are recommendations for it to be steered to any of the neighboring cells. In case there are more than one neighbor cells with a probability higher than a pre-specified threshold, the traffic steering module 60 starts from the highest priority neighbor cell and checks if the UE HO to this cell would violate any preset criteria such as PRB utilization, cell load, max number of HOs for the UE in the cell, or CQI and/or RSRP threshold violation. In the case where there is no violation, the application recommends this TS, otherwise it checks for the next highest priority.

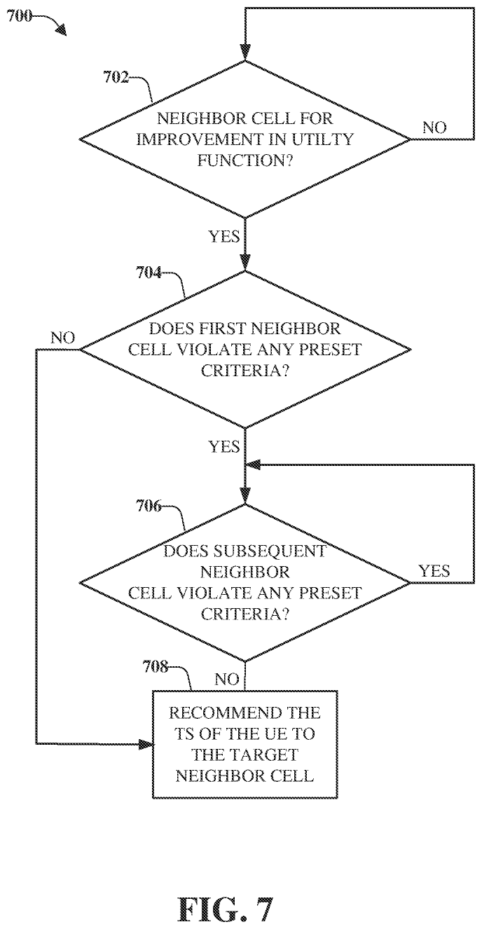

In pseudocode form, the process is described in FIG. 7, which illustrates an example, non-limiting, computer-implemented method 700 for traffic steering in accordance with one or more embodiments. At 702, a determination is made whether, for a given UE, there is one or more neighbor cells for which the GNN based model provides a threshold meeting probability of improvement in utility function. If the determination is that there is not at least one neighbor cell for which there is no probability for improvement, the computer-implemented method 700 continues, at 702, under there is at least one neighbor cell with a probability of improvement in utility function.

Alternatively, if the determination is that there is one or more neighbor cells for improvement in utility function (“YES”), at 704, starting with the neighbor cell having the highest probability of network utility improvement, a determination is made whether that neighbor cell violates any preset criteria (e.g., one or more predetermined criteria).

If it is determined at 704 that the first neighbor cell having highest probability of network utility improvement violates one or more preset criteria, at 706, a subsequent neighbor cell with a subsequent highest probability is checked to determine if that subsequent neighbor cell violates any preset criteria.

If the next checked neighbor cell does violate one or more preset criteria (“YES”), the computer-implemented method returns to 706 and a next or subsequent neighbor cell is checked. Thus, if the first neighbor cell having a first highest probability of network utility improvement violates the preset criteria at 704, a second neighbor cell with a second highest probability is checked at 706. If the second neighbor cell violates the preset criteria (“YES”), the method returns to 706 and a third neighbor cell having a third highest probability is checked, and so on, until there is one that does not violate any HO conditions (e.g., the determination at 706 is “NO”)

Upon or after the determination at 704 is that the first neighbor cell does not violate a preset condition (“NO”) or the determination at 706 is that a subsequent cell does not violate a preset condition (“NO”), at 708 the computer-implemented method can transmit a message that recommends the TS of the UE to the target neighbor cell.

The computer-implemented method 700 can be continued for all UEs within the cluster. Upon or after the process has been completed for all UEs, a cluster wide TS recommendation policy can be formulated or determined and the policy can be transferred to the relevant network layers and nodes. Thereafter, traffic steering can be automatically implemented.

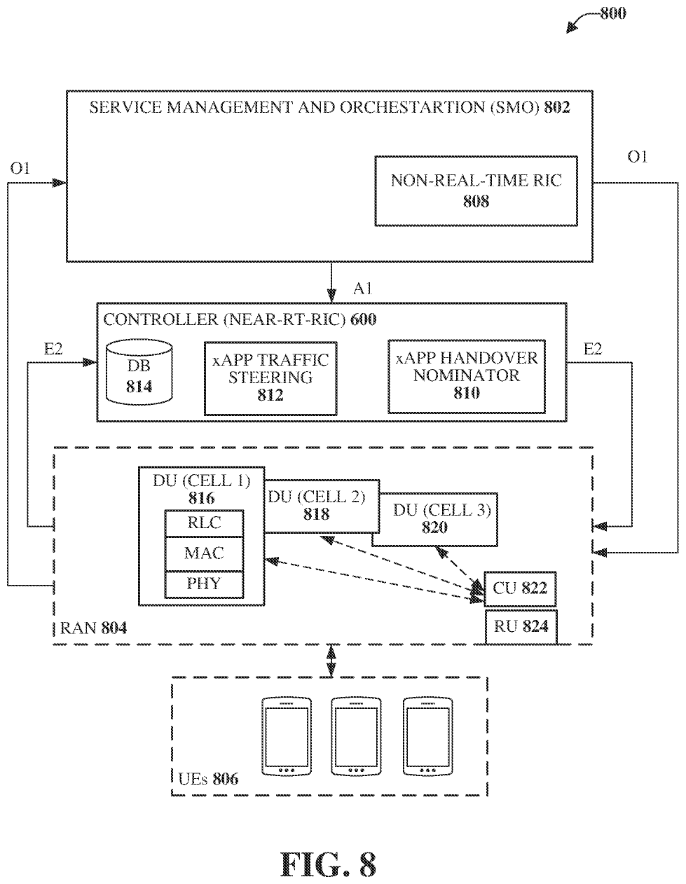

FIG. 8 illustrates an example, non-limiting, system architecture 800 in accordance with one or more embodiments described herein. Repetitive description of like elements employed in other embodiments described herein is omitted for sake of brevity. The system architecture 800 can comprise one or more of the components and/or functionality of the high-level flow diagram 300, the controller 600, the computer-implemented method 700, and vice versa.

The system architecture 800 includes an SMO 802, a Near-RT-RIC (e.g., the controller 600), and a RAN 804. Also included in the system architecture 800 are one or more UEs 806 that communicate with the RAN 804 via one or more communication links. As illustrated, the RAN 804 and SMO 802 can communicate over an O1 interface. Further, the RAN 804 and Near-RT-RIC (controller 600) can communicate over an E2 interface.

The SMO 802 can include a Non-Real-Time RIC 808. The SMO 802 can operate as the management and orchestration layer that controls configuration and automation aspects of RIC and RAN elements. The Non-Real-Time RIC 808 can be configured to retrain one or more ML models, deploy one or more ML models, and send A1 Policy updates to xApps, for example.

The controller 600 includes a first xApp 810 that can employ a handover nominator (e.g., the handover nominator module 602), a second xApp 812 that can employ traffic steering (e.g., the traffic steering module 604), and at least one database 814. The handover nominator can be responsible for utilizing ML models to predict the handovers most likely to improve the utility function, using a sequence of tree-based and GNN-based models. The traffic steering can be responsible for managing the flow of the use-case, and executes UE handovers.

Further, the RAN 804 includes one or more cells, illustrated as a first DU 816 (cell 1), a second DU 818 (cell 2), and a third DU 820 (cell 3). Although illustrated as three cells (or 3 DUs) there can be more than three. The respective DUs (e.g., the first DU 816, the second DU 818, the third DU 820) can include respective layers illustrated in the first DU 816, for purposes of simplicity, as a Radio Link Control (RLC) layer, a Medium Access Control (MAC) layer, and a Physical (PHY) layer. The respective DUs communicate with a CU 822. Also included in the system architecture 800 is a Radio Unit (RU 824).

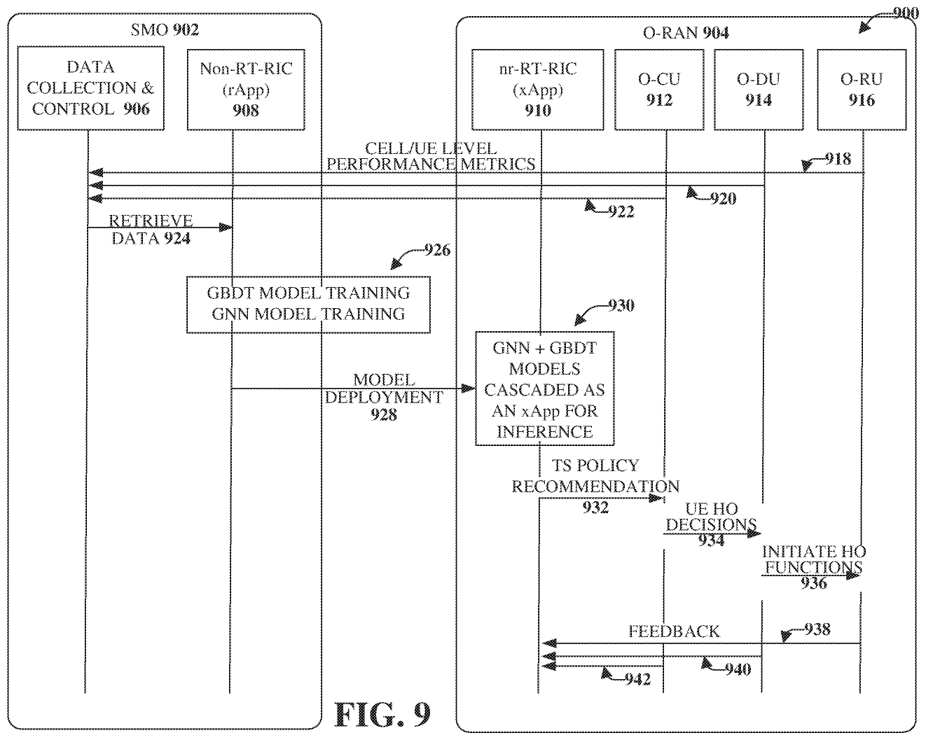

FIG. 9 illustrates an example, non-limiting, message sequence flow chart 900 that can facilitate dynamic network traffic steering using graph neural networks in accordance with one or more embodiments described herein. The message sequence flow chart 900 can be utilized for new radio, 5G, beyond 5G, and/or other advanced communication protocols, as discussed herein.

In the illustrated embodiment of FIG. 9, the proposed framework can be implemented as a disaggregated framework such as Open RAN (O-RAN). As illustrated, the message sequence flow chart 900 represents the message sequence between network equipment including a Service Management and Orchestration (SMO 902) and an O-RAN 904. The SMO 902 includes a data collection and control component (DCC 906) and a non-Real-Time-RIC (non-RT-RIC 908), which can be implemented as an rApp according to an implementation. The O-RAN 904 includes a near-Real-Time-RIC (nr-RT-RIC 910), which can be implemented as an xApp according to an implementation. The O-RAN 904 can also include an Open RAN control unit (O-CU 912), an Open RAN distributed unit (O-DU 914), and an Open RAN radio unit (O-RU 916).

As mentioned, the proposed framework can be implemented as a disaggregated framework such as Open RAN (O-RAN) based network architecture where the model is trained in the non-RT-RIC 908) using UE and/or BS location data, neighborhood adjacency information, UE channel statistics with serving and neighbor cells, HO statistics, cell load statistics and UE KPI values. The trained model is deployed at the near-RT-RIC (nr-RT-RIC 910) as an xApp where it is used for inference. Once the model performance is deteriorating, it can be retrained using recent data in the non-RT-RIC 918 and redeployed in the nr-RT-RIC 910.

With continuing reference to FIG. 9, the DCC 906 receives information indicative of cell and/or UE level performance metrics, which can include graphical data. As illustrated, this information exchange occurs where the O-RU 916, the O-DU 914, and the O-CU 912, send information (indicated at 918, 920, and 922, respectively) to the DCC 906.

As indicated at 924, the non-RT-RIC 908 retrieves data from the DCC 906. At 926 GBDT model training and GNN model training is performed, as discussed herein. The models are deployed, at 928. Further, the GNN+GBDT models are cascaded, at 930, as an xApp for inference.

A TS policy recommendation is sent from the nr-RT-RIC 910 to the O-CU 912, as indicated at 932. UE HO decisions are sent from the O-CU 912 to the O-DU 914, at 934. Further, at 936, HO functions are initiated. Upon or after the HO functions are initiated, information exchange can occur between the O-RU 916, the O-DU 914, the O-CU 912, and the nr-RT-RIC 910, as indicated at 942, 944, and 946. This information exchange can include feedback with the latest cell and/or UE level performance metrics.

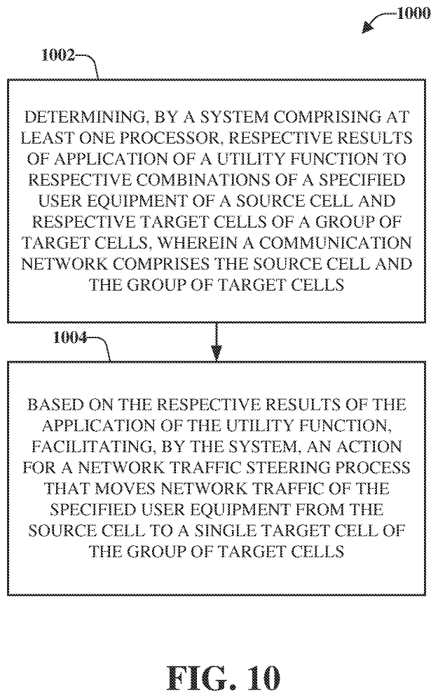

FIG. 10 illustrates a flow diagram of an example, non-limiting, computer-implemented method 1000 that facilitates traffic steering in advanced communication networks in accordance with one or more embodiments described herein. The computer-implemented method 1000 and/or other methods discussed herein can be implemented by a system comprising a processor and a memory. In an example, the system can be implemented by a network equipment of a disaggregated network architecture. It is noted that the embodiment of FIG. 10 is discussed with respect to being deployed within an O-RAN framework, however, the disclosed embodiments are not limited to an O-RAN framework.

The computer-implemented method 1000 can include, at 1002, determining, by a system comprising at least one processor, respective results of application of a utility function to respective combinations of a specified user equipment of a source cell and respective target cells of a group of target cells. A communication network comprises the source cell and the group of target cells.

The utility function can be based on an optimization function that facilitates a tradeoff between user equipment quality of service and an energy consumption of the communication network. Further, the user equipment quality of service can be defined for respective user equipment classes of user equipment within the communication network. In some implementations, the respective results of the application of the utility function can include binary classifications (e.g., either yes or no).

Determining the respective results of the application of the utility function can include determining a first result of application of the utility function to the specified user equipment and a first target cell of the group of target cells and determining a second (or subsequent) result of application of the utility function to the specified user equipment and a second (or subsequent) target cell of the group of target cells. Based on the first result being determined to satisfy a defined threshold and the second result being determined to fail to satisfy the defined threshold, selecting the first target cell as the single target cell. Thus, the first target cell can be the target cell having the highest probability of network utility improvement and does not violate any HO conditions (as discussed with respect to FIG. 7).

The computer-implemented method 1000 includes, at 1004, based on the respective results of the application of the utility function, facilitating, by the system, an action for a network traffic steering process that moves network traffic of the specified user equipment from the source cell to a single target cell of the group of target cells.

According to some implementations, the computer-implemented method 1000 can include, prior to determining the respective results of the application of the utility function, at 1002, and based on a gradient boosting process, training, by the system, a model to a defined confidence level.

In some implementations, the method can include using, by the system, a first model that determines a first output related to the network traffic steering process and using, by the system, a second model that determines a second output related to the network traffic steering process. Inputs to the second model, during a first iteration, comprise the first output of the first model, tabular input features, and a graphical network representation. The method can also include using, by the system, a third model trained to follow a loss metric of the second model, wherein an input to the third model is an error metric of the second model. Further, the method can include implementing, by the system, a gradient boosting process that comprises using an iterative process for sequential training of the second model, wherein an output of the third model is utilized as an input to the second model via a feedback loop during subsequent iterations that are subsequent to the first iteration. In an example, the first model can be a first gradient boosted decision tree model, the second model can be a graph neural network model, and the third model can be a second gradient boosted decision tree model, which can be a narrow gradient boosted decision tree model and is different than the first gradient boosted decision tree model.

As discussed herein, the various embodiments relate to facilitating traffic steering that shifts (e.g., hand over, transitions), one or more UEs from a source cell to one or more target cells. For example, if one cell is heavily loaded cell and nearby cells are not as heavily loaded, UEs can be shifted from the heavily loaded cell to one or more non-heavily loaded cell, provided that the UEs that are handed over are satisfied in terms of the received power and the QoS. Generally, UEs on edges which have good or decent receive power from the nearby cell (e.g., target cell) can be good UEs candidates to be handed over to the target cell.

Thus, provided is an AI data driven based traffic steering approach. A group of cells that are in a cluster can benefit from traffic steering of UE traffic in order to maximize a utility function, which is facilitating a tradeoff between QoS and network energy consumption. The utility function also takes into consideration the cost of traffic steering. Anytime a UE is handed over, there is some cost in terms of the signaling and/or in terms of having to move its connection from one cell to the other cell. If, for example, there are a large number of UEs that are to be handed over, the network could be overloaded with a large number of HO requests that will generate a lot of signaling overload, which is a condition that should be avoided to prevent network signaling congestion, which is also a parameter associated with the utility function. In addition, a number of times a UE has been handed over within a defined time interval is also taken into consideration.

It should be noted that terms such as “real-time,” “near real-time,” “dynamically,” “instantaneous,” “continuously,” and the like can refer to data which is collected and processed at an order without perceivable delay for a given context, the timeliness of data or information that has been delayed only by the time required for electronic communication, actual or near actual time during which a process or event occur, and temporally present conditions as measured by real-time software, real-time systems, and/or high-performance computing systems. Real-time software and/or performance can be employed via synchronous or non-synchronous programming languages, real-time operating systems, and real-time networks, each of which provide frameworks on which to build a real-time software application. A real-time system may be one where its application can be considered (within context) to be a main priority. In a real-time process, the analyzed (input) and generated (output) samples can be processed (or generated) continuously at the same time (or near the same time) it takes to input and output the same set of samples independent of any processing delay.

Example, non-limiting Non-Real Time RAN Intelligent Controller (Non-RT RIC) functions include service and policy management, RAN analytics, and model training for the near-Real Time RICs. In this regard, the Non-RT-RIC enables non-real-time (e.g., a first range of time, such as >1 second) control of RAN elements and their resources through applications, e.g., specialized applications called rApps. Example, non-limiting Near-Real Time RAN Intelligent Controller (Near-RT RIC) functions enable near-real-time optimization and control and data monitoring of O-CU and O-DU nodes in near-RT timescales (e.g., a second range of time representing less time than the first time range, such as between 10 milliseconds and 1 second). In this regard, the Near-RT RIC controls RAN elements and their resources with optimization actions that typically take about 10 milliseconds to about one second to complete, although different time ranges can be selected. The Near-RT RIC can receive policy guidance from the Non-RT-RIC and can provide policy feedback to the Non-RT-RIC through specialized applications called xApps. In this regard, a Real Time RAN Intelligent Controller (RT RIC) is designed to handle network functions at real time timescales (e.g., a third range of time representing less time than the first time range and the second time range, such as <10 milliseconds).

Methods that can be implemented in accordance with the disclosed subject matter will be better appreciated with reference to the flow charts provided herein. While, for purposes of simplicity of explanation, the methods are shown and described as a series of flows and/or blocks, it is to be understood and appreciated that the disclosed aspects are not limited by the number or order of flows and/or blocks, as some flows and/or blocks can occur in different orders and/or at substantially the same time with other blocks from what is depicted and described herein. Moreover, not all illustrated flows and/or blocks are required to implement the disclosed methods. It is to be appreciated that the functionality associated with the flows and/or blocks can be implemented by software, hardware, a combination thereof, or any other suitable means (e.g., device, system, process, component, and so forth). Additionally, it should be further appreciated that the disclosed methods are capable of being stored on an article of manufacture to facilitate transporting and transferring such methods to various devices. Those skilled in the art will understand and appreciate that the methods could alternatively be represented as a series of interrelated states or events, such as in a state diagram.

Aspects of systems, devices, apparatuses, and/or processes explained in this disclosure can constitute machine-executable component(s) embodied within machine(s) (e.g., embodied in one or more computer readable mediums (or media) associated with one or more machines). Such component(s), when executed by the one or more machines (e.g., computer(s), computing device(s), virtual machine(s), and so on) can cause the machine(s) to perform the operations described.

In various embodiments, the system can be any type of component, machine, device, facility, apparatus, and/or instrument that comprises a processor and/or can be capable of effective and/or operative communication with a wired and/or wireless network. Components, machines, apparatuses, devices, facilities, and/or instrumentalities that can comprise the system can include tablet computing devices, handheld devices, server class computing machines and/or databases, laptop computers, notebook computers, desktop computers, cell phones, smart phones, consumer appliances and/or instrumentation, industrial and/or commercial devices, hand-held devices, digital assistants, multimedia Internet enabled phones, multimedia players, and the like.

As used herein, the term “storage device,” “first storage device,” “second storage device,” “storage cluster nodes,” “storage system,” and the like (e.g., node device), can include, for example, private or public cloud computing systems for storing data as well as systems for storing data comprising virtual infrastructure and those not comprising virtual infrastructure. The term “I/O request” (or simply “I/O”) can refer to a request to read and/or write data.

The term “cloud” as used herein can refer to a cluster of nodes (e.g., set of network servers), for example, within an object storage system, which are communicatively and/or operatively coupled to one another, and that host a set of applications utilized for servicing user requests. In general, the cloud computing resources can communicate with user devices via most any wired and/or wireless communication network to provide access to services that are based in the cloud and not stored locally (e.g., on the user device). A typical cloud-computing environment can include multiple layers, aggregated together, that interact with one another to provide resources for end-users.

Further, the term “storage device” can refer to any Non-Volatile Memory (NVM) device, including Hard Disk Drives (HDDs), flash devices (e.g., NAND flash devices), and next generation NVM devices, any of which can be accessed locally and/or remotely (e.g., via a Storage Attached Network (SAN)). In some embodiments, the term “storage device” can also refer to a storage array comprising one or more storage devices. In various embodiments, the term “object” refers to an arbitrary-sized collection of user data that can be stored across one or more storage devices and accessed using I/O requests.

Further, a storage cluster can include one or more storage devices. For example, a storage system can include one or more clients in communication with a storage cluster via a network. The network can include various types of communication networks or combinations thereof including, but not limited to, networks using protocols such as Ethernet, Internet Small Computer System Interface (iSCSI), Fibre Channel (FC), and/or wireless protocols. The clients can include user applications, application servers, data management tools, and/or testing systems.

As utilized herein an “entity,” “client,” “user,” and/or “application” can refer to any system or person that can send I/O requests to a storage system. For example, an entity, can be one or more computers, the Internet, one or more systems, one or more commercial enterprises, one or more computers, one or more computer programs, one or more machines, machinery, one or more actors, one or more users, one or more customers, one or more humans, and so forth, hereinafter referred to as an entity or entities depending on the context.

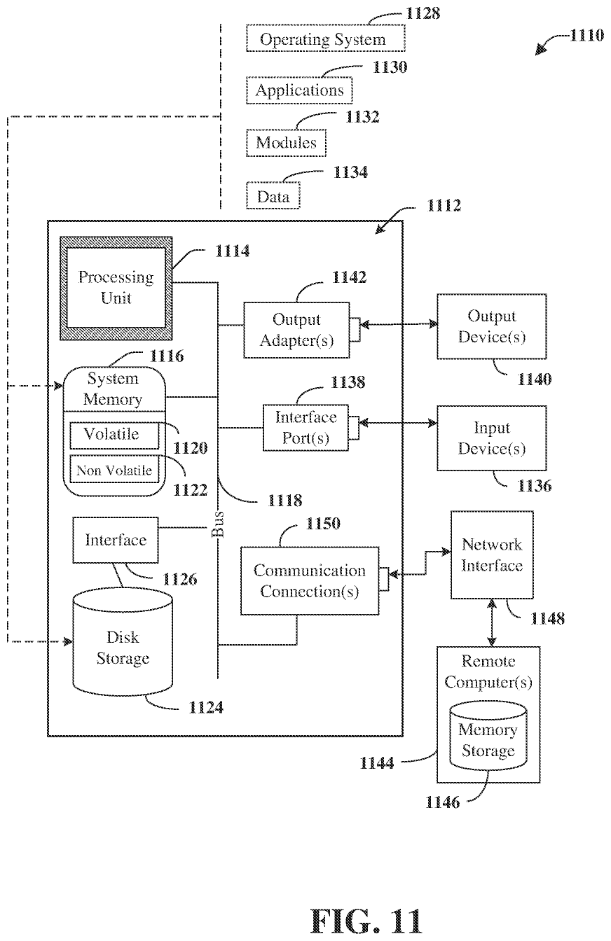

In order to provide a context for the various aspects of the disclosed subject matter, FIG. 11 as well as the following discussion are intended to provide a brief, general description of a suitable environment in which the various aspects of the disclosed subject matter can be implemented.

With reference to FIG. 11, an example environment 1110 for implementing various aspects of the aforementioned subject matter comprises a computer 1112. The computer 1112 comprises a processing unit 1114, a system memory 1116, and a system bus 1118. The system bus 1118 couples system components including, but not limited to, the system memory 1116 to the processing unit 1114. The processing unit 1114 can be any of various available processors. Multi-core microprocessors and other multiprocessor architectures also can be employed as the processing unit 1114.

The system bus 1118 can be any of several types of bus structure(s) including the memory bus or memory controller, a peripheral bus or external bus, and/or a local bus using any variety of available bus architectures including, but not limited to, 8-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

The system memory 1116 comprises volatile memory 1120 and nonvolatile memory 1122. The basic input/output system (BIOS), containing the basic routines to transfer information between elements within the computer 1112, such as during start-up, is stored in nonvolatile memory 1122. By way of illustration, and not limitation, nonvolatile memory 1122 can comprise read only memory (ROM), programmable ROM (PROM), electrically programmable ROM (EPROM), electrically erasable PROM (EEPROM), or flash memory. Volatile memory 1120 comprises random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computer 1112 also comprises removable/non-removable, volatile/non-volatile computer storage media. FIG. 11 illustrates, for example a disk storage 1124. Disk storage 1124 comprises, but is not limited to, devices like a magnetic disk drive, floppy disk drive, tape drive, Jaz drive, Zip drive, LS-100 drive, flash memory card, or memory stick. In addition, disk storage 1124 can comprise storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage 1124 to the system bus 1118, a removable or non-removable interface is typically used such as interface 1126.

It is to be appreciated that FIG. 11 describes software that acts as an intermediary between users and the basic computer resources described in suitable operating environment 1110. Such software comprises an operating system 1128. Operating system 1128, which can be stored on disk storage 1124, acts to control and allocate resources of the computer 1112. System applications 1130 take advantage of the management of resources by operating system 1128 through program modules 1132 and program data 1134 stored either in system memory 1116 or on disk storage 1124. It is to be appreciated that one or more embodiments of the subject disclosure can be implemented with various operating systems or combinations of operating systems.

A user enters commands or information into the computer 1112 through input device(s) 1136. Input devices 1136 comprise, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1114 through the system bus 1118 via interface port(s) 1138. Interface port(s) 1138 comprise, for example, a serial port, a parallel port, a game port, and a universal serial bus (USB). Output device(s) 1140 use some of the same type of ports as input device(s) 1136. Thus, for example, a USB port can be used to provide input to computer 1112, and to output information from computer 1112 to an output device 1140. Output adapters 1142 are provided to illustrate that there are some output devices 1140 like monitors, speakers, and printers, among other output devices 1140, which require special adapters. The output adapters 1142 comprise, by way of illustration and not limitation, video and sound cards that provide a means of connection between the output device 1140 and the system bus 1118. It should be noted that other devices and/or systems of devices provide both input and output capabilities such as remote computer(s) 1144.

Computer 1112 can operate in a networked environment using logical connections to one or more remote computers, such as remote computer(s) 1144. The remote computer(s) 1144 can be a personal computer, a server, a router, a network PC, a workstation, a microprocessor based appliance, a peer device or other common network node and the like, and typically comprises many or all of the elements described relative to computer 1112. For purposes of brevity, only a memory storage device 1146 is illustrated with remote computer(s) 1144. Remote computer(s) 1144 is logically connected to computer 1112 through a network interface 1148 and then physically connected via communication connection 1150. Network interface 1148 encompasses communication networks such as local-area networks (LAN) and wide-area networks (WAN). LAN technologies comprise Fiber Distributed Data Interface (FDDI), Copper Distributed Data Interface (CDDI), Ethernet/IEEE 802.3, Token Ring/IEEE 802.5, and the like. WAN technologies comprise, but are not limited to, point-to-point links, circuit switching networks like Integrated Services Digital Networks (ISDN) and variations thereon, packet switching networks, and Digital Subscriber Lines (DSL).

Communication connection(s) 1150 refers to the hardware/software employed to connect the network interface 1148 to the system bus 1118. While communication connection 1150 is shown for illustrative clarity inside computer 1112, it can also be external to computer 1112. The hardware/software necessary for connection to the network interface 1148 comprises, for exemplary purposes only, internal and external technologies such as, modems including regular telephone grade modems, cable modems and DSL modems, ISDN adapters, and Ethernet cards.

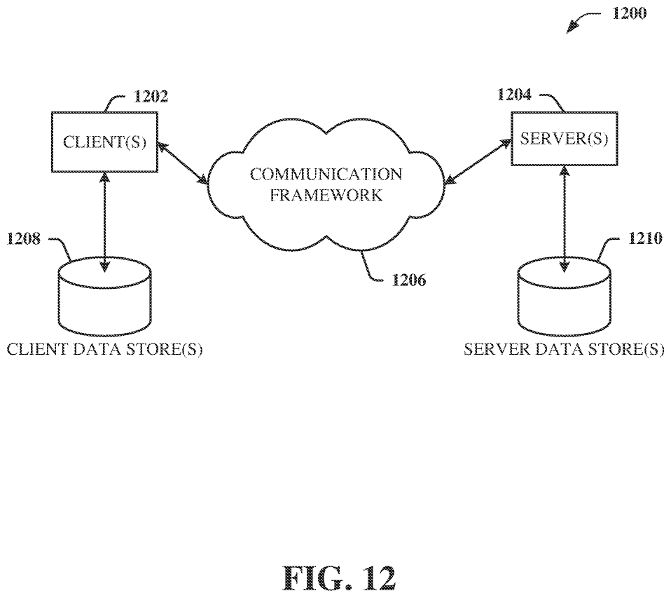

FIG. 12 is a schematic block diagram of a sample computing environment 1200 with which the disclosed subject matter can interact. The sample computing environment 1200 includes one or more client(s) 1202. The client(s) 1202 can be hardware and/or software (e.g., threads, processes, computing devices). The sample computing environment 1200 also includes one or more server(s) 1204. The server(s) 1204 can also be hardware and/or software (e.g., threads, processes, computing devices). The servers 1204 can house threads to perform transformations by employing one or more embodiments as described herein, for example. One possible communication between a client 1202 and servers 1204 can be in the form of a data packet adapted to be transmitted between two or more computer processes. The sample computing environment 1200 includes a communication framework 1206 that can be employed to facilitate communications between the client(s) 1202 and the server(s) 1204. The client(s) 1202 are operably connected to one or more client data store(s) 1208 that can be employed to store information local to the client(s) 1202. Similarly, the server(s) 1204 are operably connected to one or more server data store(s) 1210 that can be employed to store information local to the servers 1204.

Reference throughout this specification to “one embodiment,” or “an embodiment,” means that a particular feature, structure, or characteristic described in connection with the embodiment is included in at least one embodiment. Thus, the appearances of the phrase “in one embodiment,” “in one aspect,” or “in an embodiment,” in various places throughout this specification are not necessarily all referring to the same embodiment. Furthermore, the particular features, structures, or characteristics can be combined in any suitable manner in one or more embodiments.

As used in this disclosure, in some embodiments, the terms “component,” “system,” “interface,” “manager,” and the like are intended to refer to, or comprise, a computer-related entity or an entity related to an operational apparatus with one or more specific functionalities, wherein the entity can be either hardware, a combination of hardware and software, software, or software in execution, and/or firmware. As an example, a component can be, but is not limited to being, a process running on a processor, a processor, an object, an executable, a thread of execution, computer-executable instructions, a program, and/or a computer. By way of illustration and not limitation, both an application running on a server and the server can be a component.

One or more components can reside within a process and/or thread of execution and a component can be localized on one computer and/or distributed between two or more computers. In addition, these components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software application or firmware application executed by one or more processors, wherein the processor can be internal or external to the apparatus and can execute at least a part of the software or firmware application. Yet another example, a component can be an apparatus that provides specific functionality through electronic components without mechanical parts, the electronic components can comprise a processor therein to execute software or firmware that confer(s) at least in part the functionality of the electronic components. In an aspect, a component can emulate an electronic component via a virtual machine, e.g., within a cloud computing system. While various components have been illustrated as separate components, it will be appreciated that multiple components can be implemented as a single component, or a single component can be implemented as multiple components, without departing from example embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or.” That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

In addition, the various embodiments can be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, machine-readable device, computer-readable carrier, computer-readable media, machine-readable media, computer-readable (or machine-readable) storage/communication media. For example, computer-readable storage media can comprise, but are not limited to, radon access memory (RAM), read only memory (ROM), electrically erasable programmable read only memory (EEPROM), flash memory or other memory technology, solid state drive (SSD) or other solid-state storage technology, a magnetic storage device, e.g., hard disk; floppy disk; magnetic strip(s); an optical disk (e.g., compact disk (CD), a digital video disc (DVD), a Blu-ray Disc™ (BD)); a smart card; a flash memory device (e.g., card, stick, key drive); and/or a virtual device that emulates a storage device and/or any of the above computer-readable media. Of course, those skilled in the art will recognize many modifications can be made to this configuration without departing from the scope or spirit of the various embodiments.

Disclosed embodiments and/or aspects should neither be presumed to be exclusive of other disclosed embodiments and/or aspects, nor should a device and/or structure be presumed to be exclusive to its depicted element in an example embodiment or embodiments of this disclosure, unless where clear from context to the contrary. The scope of the disclosure is generally intended to encompass modifications of depicted embodiments with additions from other depicted embodiments, where suitable, interoperability among or between depicted embodiments, where suitable, as well as addition of a component(s) from one embodiment(s) within another or subtraction of a component(s) from any depicted embodiment, where suitable, aggregation of elements (or embodiments) into a single device achieving aggregate functionality, where suitable, or distribution of functionality of a single device into multiple device, where suitable. In addition, incorporation, combination or modification of devices or elements (e.g., components) depicted herein or modified as stated above with devices, structures, or subsets thereof not explicitly depicted herein but known in the art or made evident to one with ordinary skill in the art through the context disclosed herein are also considered within the scope of the present disclosure.

The above description of illustrated embodiments of the subject disclosure, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the subject matter has been described herein in connection with various embodiments and corresponding FIGs., where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

What is claimed is:

1. A method, comprising:
determining, by a system comprising at least one processor, respective results of application of a utility function to respective combinations of a specified user equipment of a source cell and respective target cells of a group of target cells, wherein a communication network comprises the source cell and the group of target cells; and
based on the respective results of the application of the utility function, facilitating, by the system, an action for a network traffic steering process that moves network traffic of the specified user equipment from the source cell to a single target cell of the group of target cells.

2. The method of claim 1, wherein the determining of the respective results of the application of the utility function comprises:
determining a first result of application of the utility function to the specified user equipment and a first target cell of the group of target cells;
determining a second result of application of the utility function to the specified user equipment and a second target cell of the group of target cells; and
based on the first result being determined to satisfy a defined threshold and the second result being determined to fail to satisfy the defined threshold, selecting the first target cell as the single target cell.

3. The method of claim 1, further comprising:
prior to the determining of the respective results of the application of the utility function and based on a gradient boosting process, training, by the system, a model to a defined confidence level.

4. The method of claim 1, wherein the method further comprises:
using, by the system, a first model that determines a first output related to the network traffic steering process;
using, by the system, a second model that determines a second output related to the network traffic steering process, wherein inputs to the second model, during a first iteration, comprise the first output of the first model, tabular input features, and a graphical network representation;
using, by the system, a third model trained to follow a loss metric of the second model, wherein an input to the third model is an error metric of the second model; and
implementing, by the system, a gradient boosting process that comprises using an iterative process for sequential training of the second model, wherein an output of the third model is utilized as an input to the second model via a feedback loop during subsequent iterations that are subsequent to the first iteration.

5. The method of claim 4, wherein the first model is a first gradient boosted decision tree model, wherein the second model is a graph neural network model, and wherein the third model is a second gradient boosted decision tree model.

6. The method of claim 1, wherein the utility function is based on an optimization function that facilitates a tradeoff between user equipment quality of service and an energy consumption of the communication network.

7. The method of claim 6, wherein the user equipment quality of service is defined for respective user equipment classes of user equipment within the communication network.

8. The method of claim 1, wherein the respective results of the application of the utility function comprise binary classifications.

9. The method of claim 1, wherein the communication network is deployed as a disaggregated architecture that comprises central units, distributed units, and a near-real-time-radio access network intelligent controller.

10. The method of claim 1, wherein the group of target cells is configured to operate according to a new radio network communication protocol.

11. A system, comprising:
a processor; and
a memory that stores executable instructions that, when executed by the processor, facilitate performance of operations, comprising:
performing a traffic steering procedure that moves network traffic of a user equipment from a source cell to a defined target cell within a communication network, wherein the performing comprises:
determining respective results of application of a utility function to respective combinations of the user equipment and respective target cells of a group of target cells of the communication network; and
based on the respective results and a determination that the defined target cell satisfies a set of handover conditions, transferring the network traffic of the user equipment from the source cell to the defined target cell.

12. The system of claim 11, wherein the operations further comprise:
prior to the determining of the respective results of the application of the utility function and based on a gradient boosting process, training a first model to a defined confidence level.

13. The system of claim 11, wherein the operations further comprise:
using a first model that determines a first output related to the traffic steering procedure;
using a second model that determines a second output related to the traffic steering procedure, wherein inputs to the second model, during a first iteration, comprise the first output of the first model, tabular input features, and a graphical network representation;
using a third model trained to follow a loss metric of the second model, wherein an input to the third model is an error metric of the second model; and
implementing a gradient boosting process that comprises using an iterative process for sequential training of the second model, wherein an output of the third model is utilized as an input to the second model via a feedback loop during subsequent iterations that are subsequent to the first iteration.

14. The system of claim 13, wherein the first model is a first gradient boosted decision tree model, wherein the second model is a graph neural network model, and wherein the third model is a second gradient boosted decision tree model.

15. The system of claim 11, wherein the utility function is based on an optimization function that facilitates a tradeoff between user equipment quality of service and an energy consumption of the communication network.

16. The system of claim 15, wherein the user equipment quality of service is defined for respective user equipment classes of user equipment within the communication network.

17. The system of claim 11, wherein the group of target cells is configured to operate according to a fifth generation network communication protocol.

18. A non-transitory machine-readable medium, comprising executable instructions that, when executed by a processor of network equipment, facilitate performance of operations, wherein the operations comprise:
determining respective results of application of a utility function to all combinations of potential handovers of the specified user equipment from a source cell to respective target cells of a group of target cells, wherein a communication network comprises the source cell and the group of target cells; and
based on the respective results of the application of the utility function, implementing a network traffic steering process that moves connectivity of the user equipment from the source cell to a single target cell of the group of target cells.

19. The non-transitory machine-readable medium of claim 18, wherein the operations further comprise:
using a first model that determines a first output related to the network traffic steering process;
using a second model that determines a second output related to the network traffic steering process, wherein inputs to the second model, during a first iteration, comprise the first output of the first model, tabular input features, and a graphical network representation;
using a third model trained to follow a loss metric of the second model, wherein an input to the third model is an error metric of the second model; and
implementing a gradient boosting process that comprises using an iterative process for sequential training of the second model, wherein an output of the third model is utilized as an input to the second model via a feedback loop during subsequent iterations that are subsequent to the first iteration.

20. The non-transitory machine-readable medium of claim 18, wherein the utility function is based on an optimization function that facilitates a tradeoff between user equipment quality of service and an energy consumption of the communication network, and wherein the user equipment quality of service is defined for respective user equipment classes of user equipment within the communication network.
